(19) United States
(12) Patent Application Publication
(10) Pub. No.: US 2011/0207441 A1
(43) Pub. Date: Aug. 25, 2011

(54) One touch text response (OTTER)

(76) Inventor: Erik Wood, Seattle, WA (US)

(21) Appl. No.: 12/928,075

(22) Filed: Dec. 3, 2010

Related U.S. Application Data
(60) Provisional application No. 61/338,607, filed on Feb. 22, 2010.

(51) Int. Cl. H04W 4/02

(52) U.S. Cl. 455/414.1

(57) ABSTRACT

OTTER is download-able software for any smartphone in the form of an application (aka: “app”). OTTER is the first app of its kind to interface with the existing smartphone GPS functions to triangulate position and determine speed while generating a texting Auto Reply to any incoming text. This is known as OTTER's GPS Mode and when it detects speed in excess of 10 miles per hour, it silences all text alerts (chimes and buzzes) and sends back an Auto Reply saying “The OTTER user is driving”. All incoming phone call ringtones are also silenced while driving unless a wireless Bluetooth device is enabled. This prevents a driver from fumbling for a ringing or buzzing phone while driving. OTTER's Parental Control feature was built to empower parents with their teen drivers. A parent can lock the aforementioned GPS Mode on a teen's phone with a session specific passcode.

### CROSS-REFERENCE TO RELATED APPLICATION

not applicable

### STATEMENT REGARDING FEDERALLY SPONSORED RESEARCH OR DEVELOPMENT

not applicable

### REFERENCE TO A COMPUTER PROGRAM LISTING COMPACT DISC APPENDIX

Computer program listing appendix; see Appendix 1—Examples of Software Code that make up the OTTER program on different smartphone operating systems (aka “OS”). These examples of the OTTER code are currently available on Android and Blackberry phones. These files are offered as evidence of functionality and viability in the current market, however OTTER is not limited to this specific code for these particular smartphone operating systems. OTTER can run on any smartphone operating system and several more versions of OTTER are currently under construction.

Contents:
Two discs total—copy 1 and copy 2 both containing:
   OTTER-Android originalAPKfile—76.8 kb
   OTTER Android APKfile in txt-read format—76.8 kb
   OTTER-Blackberry Original COD file—47.7 kb
   OTTER BlackberryCOD file in txt-read format—47.7 kb
CD transmittal letter enclosed in CD soft envelope

### BACKGROUND OF THE INVENTION

The present invention is a system that promotes personal productivity and public safety as it relates to texting. More particularly, the One Touch Text Response System (aka OTTER) is a tool by which smart phone (cellular) users can manage their texting habits to promote productivity and safety.

From the period between 2001 to 2007, Fatality Analysis Reporting System (FARS) reported that 16,141 people died in the United States directly as a result of texting while driving. A 2009 study by the Virginia Tech Transportation Institute found that “when drivers texted, their collision risk was 23 times greater than when not texting.” In June 2009, Car and Driver Magazine conducted a real world test and found that the reaction times of their test drivers to be up to two times slower while texting than while driving at the legal alcohol limit. In 2007, AAA and Seventeen Magazine conducted a survey which revealed that nearly fifty percent of teen drivers admitted to texting while driving. If that many confessed, how many more are secretly doing it? As texting usage increases exponentially (109% increase in texting in the US in 2009), the public safety needs related to distracted driving increase as well.

Local, state and federal lawmakers are moving to propose or enact legislation to ban texting while driving. While new laws may help, laws alone will not completely eliminate distracted driving. As a solution to the problem, OTTER LLC of Seattle, Wash. built the One Touch Text Response System (aka OTTER) that empowers cell phone users around the world to quickly, simply, and safely manage incoming texts.

Since OTTER LLC submitted its Provisional Patent Application (61/338,607) on Feb. 22, 2010 several companies have directly or indirectly copied the invention described in this application. The most direct copy has come from Irvine, Calif. based SMS Replier (http://www.smsreplier.com/) which released its software approximately 2 months after OTTER's release into the market on Apr. 5, 2010.

Several other companies have developed and released GPS based texting auto reply software that can be downloaded onto a smartphone but they need to be monitored from a mainframe to track user activity. These products are expensive ($20 to $200 with recurring monthly fees) and alienate the user by encroaching on their civil liberties. One such company called Zoomsafer (http://zoomsafer.com) has monthly fees and tracks user texting and smartphone activity.

The state of technology prior to the concept of the One Touch Text Response System gave no tool for individual users to manage their texting while driving habits. There were simply rules about reckless driving. Since OTTER was conceptualized more than 30 states in the United States have declared texting while driving to be illegal, yet crash rates are not dropping—in fact they are increasing with more texting drivers pulling onto our highways daily.

Furthermore, the state of technology prior to OTTER did offer some “lock down” type software options as described above that essentially disabled the users smartphone while it was moving over a pre determined speed. OTTER is a practical alternative to these invasive lock down systems. OTTER fills a need in the market and presents itself to the user as a tool and not a shackle. OTTER is based on the belief that for the texting and driving accident rates to be positively effected, the end user (driver with a smartphone) will need to change their habits and OTTER is a tool that can empower the individual to this end.

OTTER has been functional and available in Google's Android Marketplace (http://www.androidtapp.com/otter/) since Apr. 5, 2010. It is sold for $3.99 (US) one time charge, with no recurring fees.

OTTER has been functional and available in Blackberry's App World Marketplace (http://appworld.blackberry.com/webstore/content/15984?lang=en) since Nov. 4, 2010. It is sold for $3.99 (US) one time charge, with no recurring fees.

### BRIEF SUMMARY OF THE INVENTION

The One Touch Text Response System (aka OTTER) features a texting management system for the home, office, school, and—most importantly when the smartphone user is driving. OTTER interfaces with the smartphone's GPS (see FIG. 1) to detect when the smartphone user is driving. When OTTER detects speed, all text alerts (chimes and buzzes) are silenced and the incoming text receives an auto reply indicating the the “OTTER user is driving”. Phone ringtones are also silenced unless the user has a hands free wireless Bluetooth device enabled.

OTTER also features a Parental Control feature (see FIG. 2) that empowers parents to help their teen drivers break the text and drive habit. OTTER's Parental Control provides a session specific passcode that the parent can enter on a teen's phone that locks GPS Mode as described in FIG. 1 onto the teen's phone.

### BRIEF DESCRIPTIONS OF THE SEVERAL VIEWS OF THE DRAWING

FIG. 1—GPS Mode: Shows how OTTER's GPS Mode functions

FIG. 2—Parental Control feature: Shows how OTTER's Parental Control functions

FIG. 3—Android Screenshot: Displays the actual home screen shot that users who buy OTTER in the Android Marketplace will see.

FIG. 4—Blackberry Screenshot: Displays the actual home screen shot that users who buy OTTER in the Blackberry Marketplace will see

### DETAILED DESCRIPTION OF THE INVENTION

The present invention is a software that is available to any smartphone user in the form of a download-able application (aka “app”). The code that constitutes the One Touch Text Response System (aka “OTTER”) can be written for any smartphone platform using various software codes including but not limited to C++ and Java (see current, functional code examples—Appendix 1, CD).

Specifically, the present invention can be used by any smartphone user to eliminate distracted driving. It can also be used by parents of teens to eliminate their teen driver's smartphone distractions while driving.

The following description is presented to enable one of ordinary skill in the art to make and use the invention as provided in the context of a particular application and its requirements.

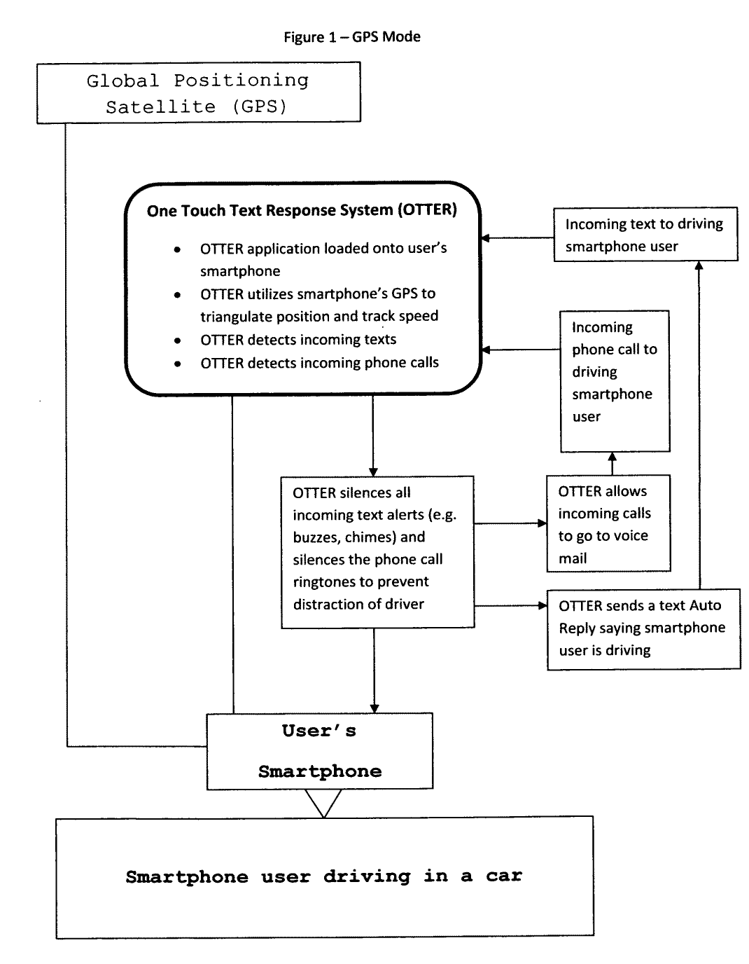

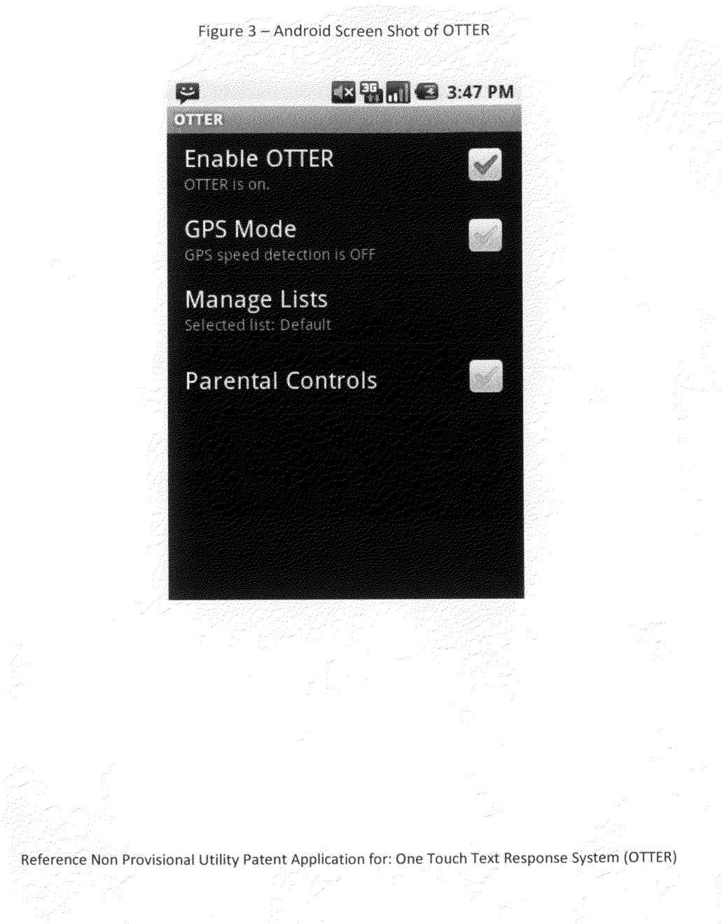

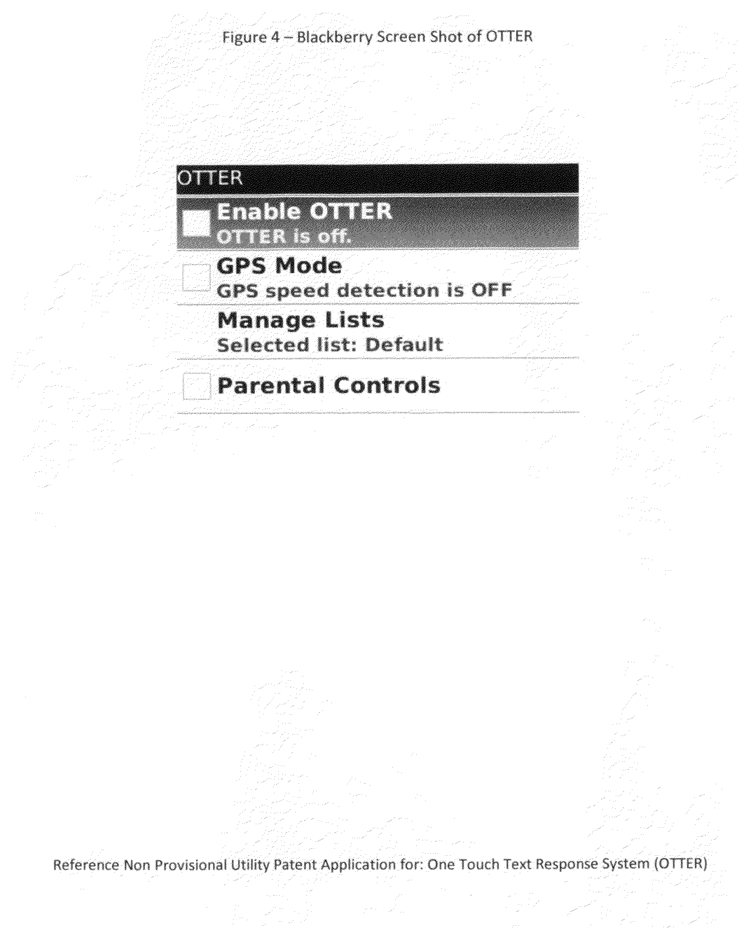

The operation and some principles of a system may be better understood with reference to the drawing and accompanying description, it being understood that these drawing are provided for illustrative purposes only and are not meant to be limiting wherein with reference to OTTER's GPS Mode:
OTTER's GPS Mode is selected on the main OTTER home screen (see FIG. 3 & FIG. 4)
OTTER's GPS Mode detects speed using a smartphone's cell tower triangulation and satellite positioning (aka “GPS”) (FIG. 1)
With OTTER's GPS Mode selected and the smartphone users' vehicle having exceeded 10 miles per hour, all Short Message Service (aks “SMS”) text messages are immediately responded to with a default reply: “The OTTER user is driving.”
The default auto reply message in GPS Mode “The OTTER user is driving” is editable by selecting it and editing to the user's needs via the existing smartphone user interface.
GPS Mode has a delay of approximately 6 minutes once a vehicle has stopped before it returns the phones notifications and sound settings back to how they were set prior to GPS Mode detecting speed. This compensates for long traffic lights while the user is still considered driving.
When GPS Mode has detected speed, it silences all smartphone incoming text alerts, chimes and buzzes that could potentially distract a driver. (FIG. 1)
When GPS Mode has detected speed, it silences all smartphone incoming phone call alerts and ringtones so that a driver is not fumbling for a ringing phone while driving. (FIG. 1)
When GPS Mode has detected speed, it will allow a hands free, wireless Bluetooth device to operate normally to take phone calls.
When GPS Mode has detected speed, all phone calls are allowed to access normal voicemail even though all volume settings are silenced (FIG. 1)
GPS Mode does not interfere with the receipt of normal SMS text messages even though all volume settings are silenced. All SMS texts that were received while the driver was driving will be available to respond to by the user like normal once they stop driving.

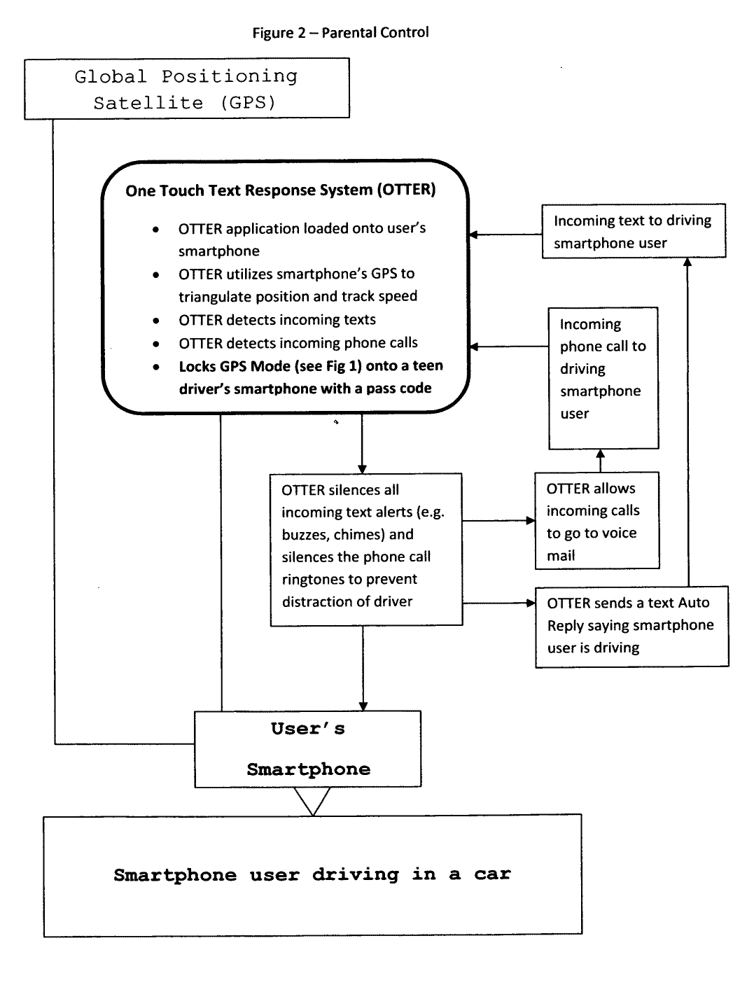

The operation and some principles of a system may be better understood with reference to the drawing and accompanying description, it being understood that these drawing are provided for illustrative purposes only and are not meant to be limiting wherein with reference to OTTER's Parental Control feature (see FIG. 2):
All features of Parental Control are exactly the same as OTTER's GPS Mode described here in (see FIG. 1) with the addition of session specific passcode that locks GPS Mode onto a users smartphone until the passcode is re entered and the session is ended.
Parental Control is enabled by selecting the Parental Control option on OTTER's home screen (see FIG. 3 and FIG. 4)
The session specific pass code consists of four number boxes in a row where the parent enters four numbers (0-9) in the teen's smartphone. The same four numbers in the same sequence are required to release the phone from GPS Mode.
The default auto reply message in Parental Control “The OTTER user is driving” is not editable by the user.
Once the phone is released from Parental Control, it is returned to the OTTER home screen (FIG. 3 and FIG. 4)
When Parental Control is selected, its check box remains visible and all other buttons on the screen are visible but greyed out indicating that they are locked in GPS Mode.

Drawings Included:
FIG. 1—GPS Mode
FIG. 2—Parental Control feature
FIG. 3—Android Screenshot
FIG. 4—Blackberry Screenshot

Oath or Declaration
attached

Sequence Listing
not applicable

1. What I claim as my invention is otter's gps mode (FIG. 1) as it is the first software in the form of a download-able app to combine gps speed detection capability with a texting auto reply to promote highway safety.

2. What I claim as my invention is OTTER's Parental Control (FIG. 2) as it is the first software in the form of a download-able app that empowers the parent of a teen driver with a session specific passcode to lock GPS Mode (FIG. 1) as described in claim #1 and herein this application on their teen's smartphone to increase highway safety.
